(19) United States
(12) Patent Application Publication
(10) Pub. No.: US 2007/0007311 A1
(43) Pub. Date: Jan. 11, 2007

(54) Fluid product delivering head and the use thereof

(75) Inventors: Luc Uytterhaeghe, Varredes (FR); Frederic Berthelin, Meaux (FR)

Correspondence Address: SUGHRUE MION, PLLC, 2100 PENNSYLVANIA AVENUE, N.W., SUITE 800, WASHINGTON, DC, 20037, US

(73) Assignee: SEAQUIST GENERAL PLASTICS, Poincy (FR)

(21) Appl. No.: 10/562,691

(22) PCT Filed: Jul. 1, 2004
(86) PCT No.: PCT/FR04/01705

§ 371 Date: Jun. 15, 2006

(30) Foreign Application Priority Data
Jul. 2, 2003 (FR) 03/08066

(51) Int. Cl. B67D 3/00

(52) U.S. Cl. 222/517; 222/518; 222/484

(57) ABSTRACT

The inventing fluid product delivering head is mounted on the orifice of a fluid product container and comprises a control flap (16, 21, 22) elastically displaceable between a closed position wherein said fluid product is unable to flow from the container through said head and an opened position which enables the fluid product to flow through the head, and a control unit (25) manually actuatable in order to move the control flap from the closed position thereof to the opened position, at least one structural element of the head being produced by comoulding two types of different plastic materials. The inventive head is characterised in that it comprises a base (1) and a cap (2) forming the first flap part (16) and second flap part (21, 22), respectively which interact with each other in such a way that the control flap is formed thereby.

The present invention relates to a preferably liquid fluid product delivering head to be mounted on an opening of a tank of fluid product, such as for example a water bottle or a water can, a drink or more generally a fluid product. The nature of the contents of the tank does not of course limit the present invention, which likewise relates to the use of such a head mounted on a tank.

The particular type of fluid product delivering head according to the present invention comprises a distribution valve displaceable elastically between a closed position, wherein the fluid product cannot flow from the tank through the head, and an open position, wherein the fluid product can flow from the tank through the head, and a manually actuatable control element for leading the distribution valve from its closed position to the open position. The valve comprises a seat and a mobile element in close contact in the closed position and moved away from pone another in the open position.

Therefore, upon depression of the control element, a part of the distribution valve shifts relative to another part to free up a flow passage for the fluid product originating from the tank. In general, such a distribution valve is made in several pieces which are then assembled to form the distribution valve. Similarly, the control element generally constitutes a separate piece to be attached when the distribution is mounted. Because of this, it is very frequent that such a distribution head is constituted by several separate pieces which are assembled together to form the distribution head. Of course, for each integral piece, it is necessary to utilise a specific mould. Because of this, the manufacturing process requires the use of several different moulds and the installation process requires the assembly of several distinct pieces.

The aim of the present invention is to simplify both the manufacture and the assembling of such a fluid product delivering head.

According to a characteristic achieving this aim, at least one element constituting the head is made by jointly moulding two different plastic materials. This characteristic is already known from the document US 2001/0054629 which describes a distributor tap with valve and control element, wherein the control element is made by jointly moulding with the body of the tap. The valve is constituted by several separate pieces mounted in the tap body. The preamble of the principal claim is based on this document.

According to another characteristic, the valve and the control element are made monobloc by moulding plastic material. Advantageously, the valve and the control element are made by successive moulding of at least two different plastic materials in the same mould. This technique of successive moulding in the same mould can likewise be designed under the term of co-moulding or bi-injection, enabling several plastic materials of different nature to be injected into a single same mould. The distribution head in its entirety is preferably made in a single and same mould. Because of this, any installation step for the distribution head is eliminated. On leaving the single mould, it is almost ready to be mounted on an opening of a tank of fluid product. The head can also be made in two or three separate, assembled pieces.

According to another interesting characteristic of the invention, the distribution head comprises a base and a cap. The cap and the base can advantageously be connected by articulation. They can also be moulded separately. The base forms a first part of the valve, the cap forming a second part of the valve to cooperate with the first part to jointly form said distribution valve. The base is intended to be mounted on the opening of the tank of fluid product, while the cap is intended to be mounted on the base.

According to another aspect of the invention, the cap is connected to the base and can be moved relative to the base between an initial moulding position and a final installation position, wherein the cap is mounted tightly on the base. In this way, when leaving the mould the distribution head is not in a final functional state: in fact, the cap needs to be forced onto the base to impart to the distribution head all its functionality. In this way, the first and second valve parts are en prise in the final installation position, whereas they are separate from one another in the initial moulding position.

Advantageously, the first part formed by the base comprises a deformable annular seat, the second part formed by the cap comprises an annular mobile element to come into close contact on said seat in the closed position.

The annular deformable seat is preferably formed by an elastically deformable annular lip. According to an advantageous embodiment, the lip is made from an elastomer plastic material, the lip being connected by co-moulding to a rigid sleeve made from a very much harder plastic material.

According to another aspect, the mobile annular element comprises a rigid socket with a free annular end for making close contact with the seat in the closed position and means for forming a flow passage for coming into non-watertight contact with the seat in the open position. Advantageously, the means for forming a flow passage comprise grooves or longitudinal fins formed on an external wall of the socket above the free annular end. In this way, when pressure is placed on the control element, the rigid socket with its longitudinal external grooves and its end annular free is moved relative to the elastically deformable annular lip connected to the fixed rigid sleeve. The effect of this is to bring the longitudinal grooves into contact with the lip which comes away from the free annular end. In this way, several flow passages are formed between the grooves in contact with the lip. As soon as the pressure on the control element is released, the rigid socket returns elastically to the initial position corresponding to the closed position of the valve.

According to another aspect of the invention, the cap forms the control element. Advantageously, the control element of the cap comprises a mobile support surface, the second part being integral in displacement with the support surface, the cap further comprising an external rigid crown in close contact with the base in the final installation position, said crown being connected to the support surface and to the second part by an elastically deformable membrane. The membrane is preferably made of an elastomer plastic material, the membrane being connected by co-moulding on the one hand to the crown and on the other hand to the support surface and to the second part, the crown, the support surface and the second part being made of a harder plastic material.

The elastically deformable membrane fulfils the function of a return spring enabling the control element and its second associated valve part to return to the rest position, corresponding to the closed position of the valve. As for the lip, the membrane is made by co-moulding or bi-injection of an elastomer material inside the single mould, in which is likewise injected a harder or more rigid plastic material which forms the remainder of the distribution head.

According to another characteristic of the invention, the distribution head comprises an entry space separated from an exit space by said valve, said exit space extending concentrically about the entry space.

Advantageously, the base forms a distribution opening communicating upstream with the exit space. On the other hand, the base can form a hole for admission of air communicating with the exit space.

The object of the present invention is likewise the utilisation of such a distribution head in sloping position with the distribution opening turned downwards and the hole for admission of air turned upwards, the fluid product coming from the tank arriving at the head by gravity. This is the case of a water fountain or more generally of a drink equipped with a distribution head on which pressure can be applied to open the distribution valve, thus allowing the fluid product to escape and simultaneous entry of air inside the tank.

The present invention will now be described in greater detail in reference to the attached diagrams giving an embodiment of the invention by way of non-limiting example, in which:

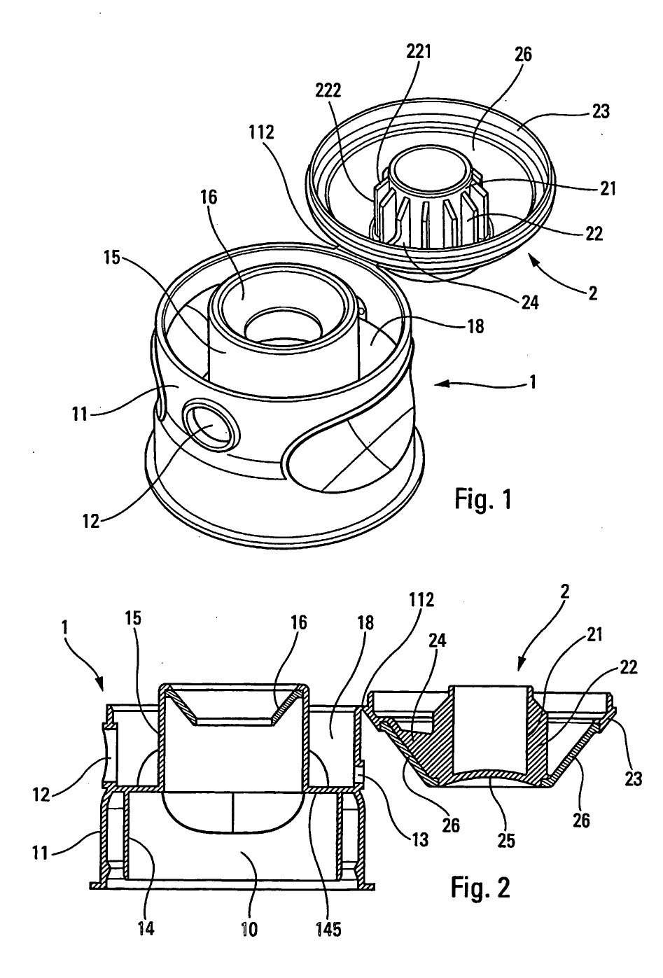

FIG. 1 is a perspective view from just above a fluid product delivering head according to the present invention in the initial position at the exit of the mould,

FIG. 2 is a view in vertical transversal section through the distribution head of FIG. 1,

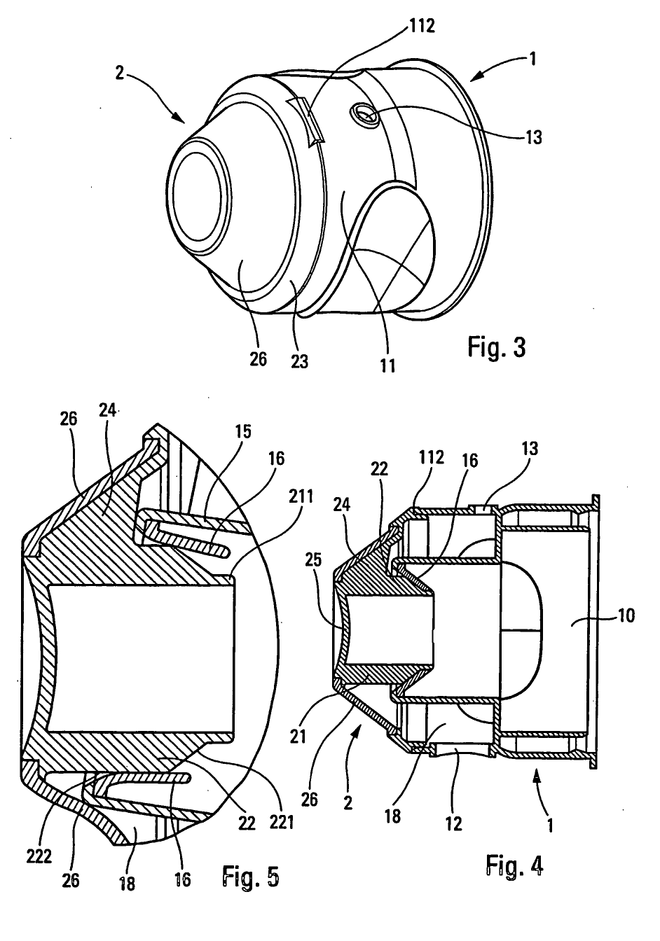

FIG. 3 is a perspective view of the distribution head of the preceding figures in the final installation position ready for use,

FIG. 4 is a view in vertical transversal section through the head of FIG. 3, and

FIG. 5 is an enlarged view of one side of the head of FIG. 4.

The distribution head comprises a base 1 and a cap 2 connected together by articulation 112. The base 1 and the cap 2 are preferably made monobloc in a single mould by injection of plastic material. One or several plastic materials with different properties can be used. Two or three materials of different rigidity can preferably be used. In the mould, the imprint of the articulation 112 constitutes a point for passing material between the base 1 and the cap 2.

It is likewise feasible that the cap is not connected to the base.

The base 1 comprises an external ring 11 of a generally substantially cylindrical shape. The ring 11 forms a distribution opening 12 and a hole for admission of air 13. The orifice 12 and the hole 13 are positioned diametrically opposite. The base 1 likewise comprises a skirt 14 which extends concentrically inside the lower part of the ring 11. The skirt 14 is supposed to make contact with an opening or a neck of a tank of fluid product. The base 1 likewise comprises a sleeve 15 which extends concentrically inside the upper part of the ring 11. The skirt 14 is connected to the sleeve 15 by an annular flange 145. The skirt 14 and the sleeve 15 internally form an entry space 10 which allows the fluid product stored inside the tank to flow through the head. The sleeve 15 is in addition provided with an annular sealing lip 16, which is here in a truncated form. The lip 16 can be made from a material different to that of the remainder of the base 1. The lip 16 and the remainder of the base can be co-moulded in a single and same mould by means of a bi-injection technique. The lip can be made from a plastic material of elastomer type, while the remainder of the base can be made from a harder or more rigid plastic material. On the other hand, the sleeve 15 and the upper part of the ring 11, at the level of which the distribution opening 12 and the admission hole 13 are formed, together form an annular distribution space 18 whereof the bottom is constituted by the annular flange 145. The distribution space extends concentrically around the entry space.

The cap 2 comprises a substantially rigid external crown 23 which is connected to the base by the articulation 112. A socket 21 extends substantially centrally and axially into the crown 23. The socket 21 is connected to the crown 23 by at least one joining flange 24. The socket 21 comprises a bottom 25. The socket 21 comprises likewise several radial fins 22 which extend on the outer periphery of the socket 21. The end free 211 of the socket is however exempt of a fin so as to form a perfectly cylindrical section. This is clearly visible in FIG. 1. The socket 21 is connected to the crown 23 by one or two joining flanges 24: all the same, the socket 21 is likewise connected to the crown 23 by an elastically deformable membrane 26 which has a truncated annular form. The membrane is fixed to the crown on the external periphery and to the socket on the internal periphery. This membrane 26 can be made from a material different to the remainder of the cap 2. The membrane can be made of elastomer, while the remainder of the cap can be made from a material harder than the membrane. Nevertheless, the membrane 26 and the remainder of the cap can be moulded in a single and same mould by a bi-injection technique, as for the lip 16.

The distribution head 1 leaves the single mould in the configuration shown in FIGS. 1 and 2: the free end 211 of the socket points upwards and the bottom 25 points down. The cap 2 is then clinched by pivoting on the base 1 so as to tightly and definitively snap-lock the crown 23 inside the ring 11. This is shown in FIGS. 3 and 4. The socket 21 is then engaged partially in the sleeve 15 with the lip 16 which comes into contact with the lower edges 221 of the fins 22, but likewise with the free end 211 of the socket. In this way, the free end of the lip 16 comes into close peripheral contact on the circumference of the socket 21, being supported on the lower edges 221. The lip 16 and the socket 21 with its grooves with fins 22 together form a distribution valve, the base forming a first part with the lip and the cap forming a second part with its socket with grooves. The valve is formed and operational only in the final installation position in FIGS. 3 to 5. In the initial configuration or position of exiting the mould, the first part is separated from the second part of the valve.

Now by pressing on the cap 2, for example at the level of the bottom 25, the elastically deformable membrane 26 will bend, as shown in FIG. 5, the effect of which is to shift the socket 21 inside the lip 16. The valve is then in the open position. The fins 22 of the socket 21 force the lip 16 to deform and break close contact with the perfectly cylindrical part 211 formed at the free end of the socket 21. The fluid product coming from the entry space 10 can then flow between the fins 22 and reach the exit space 18 formed around the sleeve 15. From there, the fluid product can flow through the distribution opening 12. At the same temps, air can penetrate through the admission hole 13 into the space 18 to then pass between the fins 21, then into the space 10 to inside the tank. The aim of air entering via the hole 13 is to compensate the quantity of fluid product distributed to the orifice 12. As soon as the pressure is released on the bottom 25 which acts as push button or control element, the elastically deformable membrane 26 returns to its closed rest position, in which the free end of the lip 16 comes into close contact on the cylindrical part 211 of the socket 21. The distribution head is then closed again.

In this way, the head can be made of one or two distinct integral elements, at least one of the elements (base-cap) being made by bi-material or tri-material jointly moulding. The lip 16 can for example be made monobloc with the same material as the remainder of the base. In this case, only the hinged or separate cap is made by-material or tri-material bi-injection bi, while the free end 211 can be made of a material different to that of the remainder of the socket, and the same as the membrane 26.

A major use for this distribution head is that where the head is positioned sloping such as shown in FIGS. 3, 4 and 5. The distribution opening 12 is located down below, while the hole 13 is oriented upwards. In this way, the fluid product which flows between the fins 22 into the exit space 18 will arrive by gravity at the level of the distribution opening 12. At the same time, air can penetrate through the hole 13. The head is preferably utilised on a tank having a fixed position, such as for example a water fountain.

1. A fluid product distributing head to be mounted on an opening of a tank of fluid product, said head comprising:
a distribution valve (16, 21, 22) displaceable elastically between a closed position, wherein the fluid product cannot flow from the tank through the head, and an open position, wherein the fluid product can flow from the tank through the head, and
a manually actuatable control element (25) for leading the distribution valve from its closed position to the open position, at least one element making up the head being made by jointly moulding two different plastic materials,
characterised in that it comprises a base (1) and a cap (2), the base forming a first part (16) of the valve, the cap forming a second part (21,22) of the valve to cooperate with the first part to form together said distribution valve.

2. The fluid product distributing head as claimed in claim 1, wherein the valve and the control element are made monobloc by moulding of a plastic material.

3. The fluid product distributing head as claimed in claim 2, wherein the valve and the control element are made by successive moulding of at least two different plastic materials in the same mould.

4. The fluid product distributing head as claimed in claim 1, wherein the cap is connected to the base by articulation (112).

5. The fluid product distributing head as claimed in claim 1, wherein the cap (2) is connected to the base (1) and can be moved relative to the base (1) between an initial moulding position and a final installation position, wherein the cap is mounted tightly on the base.

6. The fluid product distributing head as claimed in claim 1, wherein the first and second parts of the valve are clamped in the final mounting position, whereas they are separated from one another in the initial moulding position.

7. The fluid product distributing head as claimed in claim 1, wherein the first part formed by the base comprises a deformable annular seat (16), and the second part formed by the cap comprises an annular mobile element (21) to come into close contact on said seat in the closed position.

8. The fluid product distributing head as claimed in claim 7, wherein the deformable annular seat is formed by an elastically deformable annular lip (16).

9. The fluid product distributing head as claimed in claim 8, wherein the lip is made from an elastomer plastic material, the lip being connected by co-moulding to a rigid sleeve (15) made from a harder plastic material.

10. The fluid product distributing head as claimed in claim 7, wherein the mobile annular element comprises a rigid socket (21) comprising an annular free end (211) supposed to come into close contact with the seat (16) in the closed position and means for forming a flow passage (22) to come into non-watertight contact with the seat (16) in the open position.

11. The fluid product distributing head as claimed in claim 10, wherein the means for forming a flow passage comprise longitudinal fins (22) formed on an external wall of the socket above the free annular end (211).

12. The fluid product distributing head as claimed in claim 1, wherein the cap (2) forms the control element (25).

13. The fluid product distributing head as claimed in claim 12, wherein the control element of the cap comprises a mobile support surface (25), the second part (21, 22) being integral in displacement with the support surface (25), the cap further comprising a rigid external crown in close contact with the base (1) in the final mounting position, said crown (23) being connected to the support surface (25) and to the second part (21, 22) by an elastically deformable membrane (26).

14. The fluid product distributing head as claimed in claim 13, wherein the membrane is made of an elastomer plastic material, the membrane being connected by co-moulding on the one hand to the crown and on the other hand to the support surface and to the second part, the crown, with the support surface and the second part being made of a harder plastic material.

15. The fluid product distributing head as claimed in claim 1, comprising an entry space (10) separate from an exit space (18) by said valve, said exit space extending concentrically around the inlet space.

16. The fluid product distributing head as claimed in claim 15, wherein the base (1) forms a distribution opening (12) communicating upstream with the exit space (18).

17. The fluid product distributing head as claimed in claim 16, wherein the base (1) forms a hole for admission of air (13) communicating with the exit space (18).

18. Use of a fluid product distributing head as claimed in claim 14 in the sloped position with the distribution opening (12) turned downwards and the hole for admission of air (13) turned upwards, the fluid product coming from the tank reaching the head via gravity.
